(19) United States
(12) Patent Application Publication
(10) Pub. No.: US 2022/0196208 A1
(43) Pub. Date: Jun. 23, 2022

(54) Method for producing a leak-tight vessel and leak-tight vessel obtained thereby

(71) Applicant: Covess N.V., Hasselt (BE)

(72) Inventor: Tony Vanswijgenhoven, Hasselt (BE)

(21) Appl. No.: 17/603,976

(22) PCT Filed: Apr. 28, 2020
(86) PCT No.: PCT/EP2020/025195

§ 371 Date: Oct. 15, 2021

(30) Foreign Application Priority Data
Apr. 29, 2019 (BE) 2019/0035

(51) Int. Cl. F17C 1/16; B29C 53/60

(52) U.S. Cl. CPC F17C 1/16; B29K 2101/12; B29C 53/602

(57) ABSTRACT

The invention relates to a method for the manufacture of a leak-tight vessel comprising a cylindrical mantle and two dome-shaped ends for the storage of a gas and/or a liquid. The method comprises providing an inner barrier layer comprising a heat-sealable thermoplastic material and an outer shell layer comprising a fiber-reinforced heat-sealable thermoplastic material, as well as an end-fitting. Further, the method comprises providing an inner layer by winding a heat-sealable thermoplastic filament material and forming an outer layer in two steps: first providing around the mantle of the vessel a fabric of a fiber-reinforced heat-sealable material, whereby the width of the fabric diminishes with successive windings of the fabric around the mantle, followed by winding a fiber-reinforced heat-sealable plastic film over the fabric around the mantle and the dome-shaped endings.

### RELATED APPLICATIONS

This application is a § 371 National Phase Application of International Application No. PCT/EP2020/025195, filed on Apr. 28, 2020, now International Publication No. WO 2020/221475 A1, published on Nov. 5, 2020, which International Application claims priority to Belgian Application 2019/0035, filed on Apr. 29, 2019, both of which are incorporated herein by reference in their entirety.

### TECHNICAL FIELD

The invention relates to a method for producing a leak-tight vessel and to a leak-tight vessel produced according to such method.

### BACKGROUND OF THE INVENTION

Leak tight vessels comprising a fiber reinforced material as their wall structure and methods for producing them are known in the art.

With “leak-tight vessel” is meant a substantially liquid-tight vessel or a substantially gas-tight vessel or both, wherein the permeability of the vessel for the liquid and/or gas to be stored inside the vessel is below a maximum prescribed limit for the given application the vessel is intended for.

For example, in case the application is a hot water boiler application, the relevant permeability is the permeability of hot water under the intended storage conditions (e.g. temperature, pressure).

For example, in case the application is a high-pressure hydrogen storage tank for use in vehicles, the relevant permeability is the permeability of the gas under the intended high pressure storage conditions.

With “gas and/or liquid tight” is meant that it can be gas tight, or liquid tight, or both, depending on the intended application.

A known method for making leak-tight vessels, in particular pressure vessels, uses filament winding of continuous fibers impregnated with a thermoset resin over an inner bottle (also called “liner”) that will remain in the vessel after the filament winding step. The inner bottle is sufficiently rigid to be tightly overwrapped with continuous fibers, and is quite thick (e.g. 1-4 cm) to act as the gas and/or liquid barrier. A disadvantage of such a method is that the bottle (liner) is heavy and expensive.

Because during filament winding of continuous fibers a large pressure is exerted upon the object being wound, the plastic bottle needs to be sufficiently thick (e.g. 3-5 mm thick for a diameter of about 50 cm). At the same time, such a bottle also acts as the gas and/or liquid barrier for the leak-tight vessel, while the fibers wound around the bottle act as a protection layer. When producing pressure vessels, the inner bottle is usually made of a thermoplastic material, in order to avoid cracks due to the internal pressure. While such a bottle can provide a high barrier for the gas and/or liquid, it is heavy and expensive.

In the international (PCT) patent application published under number WO 2011/143723 A2, on Nov. 24, 2011, in the name of Covess N. V., Belgium, a method has been described for the production of a leak-tight vessel, whereby as well the inner (leak-tight) layer as the outer (strength or shell) layer are provided around a removable mandrel through winding, and whereby the material of as well the inner as the outer layer comprises a thermoplastic heat-sealable plastic. After consolidation of both layers a unitary rigid structure is obtained.

In practice, this method offers numerous advantages. However, a drawback of this method is that in particular for vessels with relatively large dimensions, and more in particular for vessels that need to store gasses under high pressure, the winding of in particular the outer layer is an inefficient operation.

For storage vessels characterised by a given pressure strength, an excessive amount of material needs to be used.

This in turn not only gives rise to an extraordinary heavy vessel, it also increases the manufacturing cost of the vessel given the high use of raw material.

### DESCRIPTION OF THE INVENTION

It is an object of the present invention to provide a method for producing a leak-tight vessel and a leak tight vessel produced according to such method, thereby avoiding the disadvantages and problems associated with the prior art vessels and manufacturing methods described above.

More particularly, it is an object of the present invention to provide leak-tight vessels and their manufacturing methods, able to resist high pressures and whereby the consumption of raw materials is limited.

After years of experimenting the inventor has found such a method. This goal is achieved according to the present invention, as described in the appended method claims.

The invention also relates to leak-tight vessels suitable for high-pressure storage of in particular gasses and that are produced according to the methods as described.

To that end, the method of the present invention comprises the manufacture of a leak-tight vessel comprising a cylindrical mantle and two dome-shaped endings for the storage of a gas and/or a liquid, comprising:
an inner barrier layer comprising a heat-sealable thermoplastic material;
an outer shell layer comprising a fibre-reinforced heat-sealable thermoplastic material;
an end fitting positioned at the inner side of the inner barrier layer or in-between the inner and outer layer.

Further the method comprises the following steps:
a) mounting a removable mandrel suitable for filament winding;
b) mounting an end fitting either to the mandrel, or after completion of step (c) described hereinafter, on the inner layer, said end fitting comprising an opening suitable for removing the mandrel there through after disassembly;
c) forming an inner layer by winding of a heat-sealable thermoplastic material either around the mandrel or around the end fitting and the mandrel, while leaving the opening large enough for removing the mandrel after disassembly;
d) forming an outer layer in two steps:
   (d1) providing by winding around the mantle of the vessel a fabric of fiber-reinforced heat-sealable material, whereby the width of the fabric diminishes with successive windings of the fabric around the mantle;
   (d2) winding a fiber-reinforced heat-sealable material over the fabric provided in step (d1) around the mantle and the dome-shaped endings, while leaving the opening large enough for removing the mandrel after disassembly;
e) consolidating the inner layer whereby a gas- and/or liquid tight layer is formed and whereby this step (e) is applied either concomitantly with and/or following to step (c), and/or following step (d);
f) consolidating the inner barrier layer with the end fitting, thereby forming a gas and/or liquid tight connection of the inner layer and the end fitting, this step (f) being performed either concomitantly with and/or following step (e);
g) consolidating the outer layer formed in step (d) with the inner layer formed in step (e) so as to form a consolidated wall structure, this step (g) being performed either concomitantly with and/or following any of steps (e) or (f);
h) disassembling and removing the mandrel through the opening.

Further preferred embodiments of the invention are described in the appended dependent claims.

Further, according to the invention, leak-tight vessels are produced according to the method described above.

### BRIEF DESCRIPTION OF THE DRAWINGS

The invention is further elucidated in the appending figures and figure description explaining preferred embodiments of the invention. Note that figures are not drawn to scale. The figures are intended to describe the principles of the invention.

FIG. 1 shows a removable mandrel with a rounded outer surface suitable for filament winding, as can be used for producing a leak-tight vessel according to the present invention.

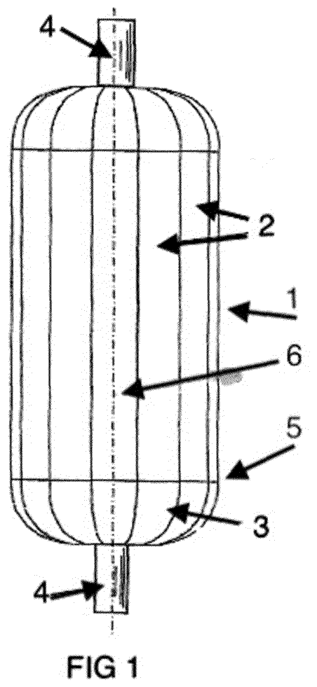

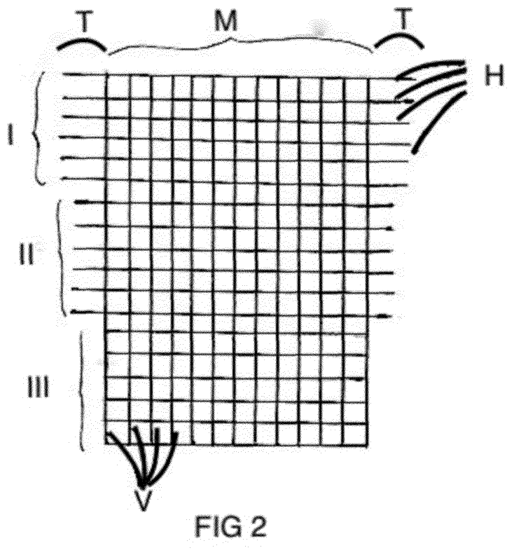

The mandrel comprises elongated segments (2) that are placed side by side to form a cylindrical mantle and dome-shaped endings with a rounded outer surface. The mandrel has a rotation symmetrical shape around a symmetry axis (6) and is suitable for filament winding.

Shown on the drawing is the central cylindrical part of the mandrel (1), and the two dome-shaped endings (3). Upon completion of the method according to the present invention, these will give rise to the central cylindrical part (mantle) of the leak-tight vessel, and the corresponding two dome-shaped endings of the leak-tight vessel.

Indicated by reference numeral (5) is the transition zone, this is the zone where the central cylindrical part of the mandrel gradually changes into the dome-shaped ending.

Reference arrow (4) indicates spind1e parts that hold the elongated segments (2) in position during the vessel manufacturing process.

FIG. 2 shows a schematic drawing of a fabric that can be used in the method of the present invention (step (d1)). This drawing visualises a fabric with an orthogonal structure of woven filaments. Filaments in one direction, indicated by reference numeral H (Horizontal), together with filaments in another direction, indicated by the reference numeral V (Vertical), are woven to form together a fabric. Preferably, as will be explained further in the detailed description, the directions of the two pairs of filaments are woven under an angle of 90°0 with respect to each other.

Indicated by the reference numerals I, II and III respectively are a first, second and third part of the fabric that can be wound around (the mantle of) the vessel. Any number of successive windings can be selected; in this drawing, the fabric is suitable for three successive windings around the mantle. As shown in the drawing, the width of the first part of the fabric (indicated by I), suitable for the first winding around the mantle, is larger that the width of the second part of the fabric (indicated by II). The width of this second part of the fabric (II) is larger than the width of the third part of the fabric (III).

Reference numeral M indicates the width of the mantle of the vessel to be manufactured according to the method of the invention. Reference numerals T (left and right of the mantle) indicated the Transition zones, these are the zones where the mantle of the vessel gradually transites into the dome-shaped endings. According to a preferred embodiment of the invention, one pair of filament threads (H) extend beyond the boundaries of the woven fabric. In such a case, whereas the fabric upon winding covers e.g. the mantle of the vessel, the extended filament threads cover the transitions zones of the vessel during such first winding. As can be seen from the drawing, the length of these extended filaments for the next part of the fabric that is wound around the vessel, are shorter as compared to the length of the extended filaments used in the first winding.

For the part of the fabric that is wound around the vessel in the next wounding round, no extensions are available any more.

The above sequence illustrates a particular embodiment of how the width of the fabric, including its extended filament threads, gradually diminishes with each successive winding of the fabric around the vessel.

Various alternative embodiments for diminishing the width of the fabric with each successive winding around the mantle can be applied.

### DETAILED DESCRIPTION OF THE INVENTION

As used herein, with “consolidation of two or more materials” is meant unification or leak-tight connection, e.g. in the context of two thermoplastic materials consolidation can mean uniting under high temperature by local melting or softening; e.g. in the context of consolidating a plastic material with a metal material, consolidation can mean melting against the metal surface, or gluing to the metal surface.

The method for the manufacture of the leak-tight vessel according to the invention comprises various steps as described in the international PCT patent application as cited above, WO 2011/143723 A2. More in particular the invention relates to a modified method described in this applicaiton. The modification relates to the fact that step d of the method described in this application is split into two partial steps, d1 and d2, as described supra.

For the sake of convenience, we do not describe in detail hereinafter the other steps of the present invention as these steps correspond to the corresponding steps of the invention described in this international application.

So, the method of the present invention differs from the method described in this international application in this respect that in the method of the present invention, the step for providing the outer shell layers is split into two partial steps (d1 and d2); all other steps of the method of the present invention correspond to the corresponding steps of the method described in this international application.

In case the method for providing the outer or shell layer as described in this PCT application is applied, then, as a result of the commonly-used winding pattern, the filament plastic material for the formation of the outer or shell layer is provided on the surface of the vessel in a non-uniform manner.

This is caused as the filament threads can only be applied on the surface of the vessel according to a well-defined angle with respect to the vessel itself. This in turn leads to the situation that a disproportionate amount of material is provided at the dome-shaped endings, more in particular at the dome-shaped endings short around the central axis-line and less around for example the transition zone from the central cylinder-shaped shell to the dome-shaped endings.

In case the vessel as a whole needs to meet certain standards of strength, and as a result, a minimal amount of material needs to be winded over the whole surface of the vessel, then, under the working assumption that the traditional winding method known in the prior art is applied, in such a case at the dome-shaped endings of the vessel (much) more material will be provided than strictly necessary, whilst at the central cylindrical shell, the minimally necessary amount of material will be provided.

This problem is also caused by the fact that the highest strength of the material provided by filament winding can be reached in case the successive filament threads can be provided at right angles with respect to each other. Indeed, the strength obtained by consolidated filament threads is the highest in case the successive filament threads have been applied orthogonal with respect to each other, or under an angle of 90°.

However, this ideal angle of weaving or winding cannot be applied when winding the fiber-reinforced thermoplastice heat-sealable filament threads around a mandrel for the formation of a leak-tight vessel. When a state of the art winding technique is applied, is is not possible to apply the filament threads around the vessel in such a manner that the angle formed by successive windings amounts to 90°, or even approximates this value.

As a result of this disadvantage, when the winding techniques known in the state of the art are applied, and in order to reach a given pressure strength for the vessel, much more material will be used as compared to the (ideal but practically not applicable) situation whereby successive filament threads would be wound under the ideal orthogonal angle of 90° with respect to each other.

The inventors of the present invention now have found that the advantages of on the one hand the ideal weaving technique comprising filament threads woven orthogonally with respect to each other, and on the other hand the winding of filament threads around a vessel already comprising an inner wound layer, can be combined with each other by applying the method of the present invention.

The characterizing feature of the present invention, as compared to the known method from WO 2011/143723 A2, resides in the fact that the step for forming the outer shell layer is split into two partial steps.

In the first partial step a pre-fabricated fabric or tissue of fiber-reinforced material is provided around the shell or mantle of the vessel or the tank. In this step this pre-fabricated fabric is applied to, e.g. by winding same over, the central or cylindrical part of the vessel or tank. This step can e.g. be accomplished when the vessel turns around its central axis, preferentially in a horizontal position, and the fabric, wound around a rol, is unwound from said rol and applied over the length of the cylindrical central part of the vessel.

The number of layers that needs to be applied in such a manner, or the number of woundings that need to be applied to the cylindrical central part of the tank, varies according to the desired application. It also varies depending on the size, more in particular on the diameter of the vessel. The larger the diameter and the higher the working pressure of the vessel in operation, the more layers will need to be applied. According to a preferred embodiment, minimal two and up to maximum 10 windings of fabric need to be applied, more preferably from 3 to 8, still more preferably from 4 to 6.

Further, according to the invention, the width of the fabric diminishes with each successive winding around the cylindrical central part of the vessel. According to a further preferred embodiment, this reduction in width is applied stepwise with each successive winding.

According to a further preferred embodiment, the fabric covers in step (d1) not only the cylindrical central part of the vessel, but also the transition zones from this central cylindrical part to both dome-shaped endings of the vessel.

The fabric comprises plastic filaments that are woven orthogonally with respect to each other, or plastic filaments that are woven with respect to each other under an angle close to 90°.

An example of such a woven fabric is available from the company Composites Plaza at the following website: https://compositesplaza.com/nl/producten/koolstof-carbon/koolstof-carbon-weefsels/design-koolstof-carbon-weefsels

Said company offers to the market design carbon fabrics with special bindings, various patterns and weights. As well aramide reinforced as carbon or fiber glass reinforced tape-fabrics are offered for sale.

Another example is the material known under the brand name Smart Hybride™, offered by Texonic Inc., 445, rue St-Jacques, Saint-Jean-sur-Richelieu, Québec J3B2M1, Canada.

According to a further preferred mode of operation, the width of the fabric for the first winding around the cylindrical or central part of the vessel is comprised between 105 and 115% of the length of the cylinder-shaped mantle; preferably the width of the to be wound fabric diminishes with each successive winding with around 3 to 7%.

For a vessel with a length of the central cylindrical mantle of for example 1 meter, the width of the first winding of fabric may amount to approximately 110 cm, for the next (second) winding, the width may amount to approx. 107 cm, for the next (third) winding, the width may amount to approx. 104 cm, for the next (fourth) winding, the width may amount to approx. 100 cm.

Upon completion of this step, so upon application of the fabric around the central part of the vessel, step d2 may be applied.

This amounts to the traditional winding step whereby the fiber-reinforced heat-sealable thermoplastic material is wound around the vessel. Usually in this step, the material is fed to the winding mechanism in the form of a filament or tape. According to a further preferred embodiment of the method according to the present invention, in step (d2) the material is wound around the vessel filament-wise, for example in a first step cross-wise whereby the vessel turns relative to the filament thread fed to the vessel and thereafter in a transverse manner over the mantle of the vessel. Also, the reverse method can be applied, whereby first a transverse mode followed by a cross-wise mode is applied.

The big advantage of the mode of operation according to the present invention over the method of the prior art is that substantially less material is consumed. Apart from this saving in raw material, also a substantive saving in production time is realized. The overall result is that the material is provided on the vessel in both partial steps d1 and d2 in a much more uniform manner over the complete surface as compared to the state of the art.

Indeed, in the case of a pressure vessel used e.g. for the storage of hydrogen in vehicles, the pressure on the vessel is uniform or equal, but the force exerted on the central cylinder-shaped part of the vesses is the highest.

When the traditional winding process is applied, on this part however, a proportionally lower amount of fiber is applied.

When the method according to the present invention is used, the material is applied in a much more uniform manner over the complete surface of the vessel. This in turn results in globally less material consumption for a vessel that should meet a given working pressure. On turn, this results in a much more effective and efficient raw material consumption, and consequently a vessel with a pronounced lower weight. This offers advantages not only in mounting and use of the vessel, but also in terms of manufacturing cost.

Finally, the method of the present invention is applicable not only to the manufacture of pressure vessels manufactured according to the method described above, with reference to the international patent application number WO 2011/143723 A2, but also to pressure vessels with a traditional liner, as cited supra in the description of the background art, or on pressure vessels that can be manufactured according to the method described in the Belgian patent application filed on Jul. 12, 2011 with filing number BE 2011/0441 and published on Dec. 4, 2012 as publication number BE 1019794 A5.

1-12. (canceled)

13. A method for the manufacture of a leak-tight vessel comprising a cylindrical mantle and two dome-shaped endings for the storage of a gas and/or a liquid, the vessel comprising:
an inner barrier layer comprising a heat-sealable thermoplastic material;
an outer shell layer comprising a fiber-reinforced heat-sealable thermoplastic material;
an end fitting positioned at the inner side of the inner layer or in-between the inner and outer layer,
the method comprising:
a) mounting a removable mandrel suitable for filament winding;
b) mounting an end fitting either to the mandrel, or after completion of step (c) described hereinafter, on the inner layer, said end fitting comprising an opening suitable for removing the mandrel there through after disassembly;
c) forming an inner layer by winding of a heat-sealable thermoplastic material either around the mandrel or around the end fitting and the mandrel, while leaving the opening large enough for removing the mandrel after disassembly;
d) forming an outer layer in two steps:
(i) providing by winding around the mantle of the vessel a fabric of fiber-reinforced heat-sealable material, whereby the width of the fabric diminishes with successive windings of the fabric around the mantle;
(ii) winding a fiber-reinforced heat-sealable material over the fabric provided in step (i) around the mantle and the dome-shaped endings, while leaving the opening large enough for removing the mandrel after disassembly;
e) consolidating the inner layer whereby a gas-tight layer or liquid-tight layer or both is formed and whereby this step (e) is applied either concomitantly with and/or following step (c), and/or following step (d);
f) consolidating the inner layer with the end fitting, thereby forming a gas and/or liquid tight connection between the inner layer and the end fitting, this step (f) being performed either concomitantly with or following step (e) or both;
g) consolidating the outer layer formed in step (d) with the inner layer formed in step (e) so as to form a consolidated wall structure, this step (g) being performed either concomitantly with and/or following any of steps (e) or (f); and
h) disassembling and removing the mandrel through the opening.

14. The method according to claim 13, whereby in step (d)(i) the width of the fabric diminishes stepwise with each winding of the fabric around the mantle.

15. The method according to claim 13, whereby in step (d)(i) the fabric covers the mantle and the transition zones from the mantle to both dome-shaped endings of the vessel.

16. The method according to claim 13, whereby the fabric comprises woven plastic filaments and whereby, preferably, the filaments are woven orthogonally with respect to each other.

17. The method according to claim 14, whereby the width of the fabric for the first winding is comprised between 105 and 115% of the length of the mantle, and preferably the width of the fabric for each further winding diminishes with respect to the width of the preceding winding with 3 to 7%.

18. The method according to claim 13, whereby in step (c), resp. in step (d)(ii), the heat-sealable thermoplastic material is wound as a filament.

19. The method according to claim 13, whereby in step (d)(ii) the plastic is wound around the vessel as a filament, first cross-wise whereby the vessel turns relative to the filament fed to the vessel, and subsequently in a transverse direction around the periphery of the mantle of the vessel.

20. The method according to claim 13, whereby in step (d)(ii) a pressure is exerted on the wound inner layer and the wound fabric, such that the windings of the inner layer and the fabric are pressed against the mandrel and against each other such that the windings of the inner layer and the fiber-reinforced fabric are consolidated at their contacting surfaces.

21. The method according to claim 13, whereby the plastic used in the steps (d)(i) and (d)(ii) is a thermoplastic material reinforced with carbon or glass or both, or comprises stretched thermoplastic fibers, preferably impregnated with a thermoplastic.

22. A leak-tight vessel for the storage of a gas or a liquid or both, manufactured according to a method according to claim 13, whereby the inner layer, the outer layer and the end-fittings are one rigid structure and whereby the outer layer comprises consolidated fiber-reinforced heat-sealable thermoplastic fabrics, the width whereof diminishes towards the outer surface of the vessel.

23. A leak-tight vessel according to claim 13 whereby the outer layer comprises a fabric and wound filaments comprising glass- or carbon-fibers, co-mingled, impregnated or pre-impregnated with a heat-sealable thermoplastic material.

24. A leak-tight vessel according to claim 13, whereby the end-fitting comprises an opening suitable for removal, after disassembly, the mandrel used in the manufacturing method.
